(19) United States
(12) Patent Application Publication
(10) Pub. No.: US 2019/0126793 A1
(43) Pub. Date: May 2, 2019

(54) APPARATUS AND SYSTEM FOR IMPROVING SITTING POSTURE

(71) Applicant: Shirley Tan, San Francisco, CA (US)

(72) Inventor: Shirley Tan, San Francisco, CA (US)

(21) Appl. No.: 16/228,234

(22) Filed: Dec. 20, 2018

Related U.S. Application Data
(63) Continuation-in-part of application No. 15/938,243, filed on Mar. 28, 2018.
(60) Provisional application No. 62/488,615, filed on Apr. 21, 2017.

(51) Int. Cl. B60N 2/66; A47C 7/42; B60R 22/12

(52) U.S. Cl. CPC B60N 2/663; B60R 22/12; A47C 7/425

(57) ABSTRACT

An apparatus for improving the sitting posture of a user is provided. The apparatus includes a back support member configured to rest against the backrest of a seat. A pair of shoulder straps having a pair of adjustable harnesses is attached to the back support member, the straps and harnesses configured to secure the user to the seat during use. Once secured, the user is prevented from leaning forward too much; keeping the neck properly aligned to minimize the negative health effects of poor posture. A quick release is provided allowing the user to be free from constraint.

### CROSS-REFERENCE TO RELATED APPLICATIONS

The present invention claims priority to U.S. patent application Ser. No. 15/938,243, filed Mar. 28, 2018 “Apparatus and method for improving sitting posture” which claims the benefit of Provisional Application Ser. No. 62/488,615, filed Apr. 21, 2017 entitled “Apparatus and method for improving sitting posture”, the disclosures of which are hereby incorporated in its entirety at least by reference.

### BACKGROUND OF THE INVENTION

### 1. Field of the Invention

The present invention relates generally to sitting position and posture, but more particularly to an apparatus and system for improving sitting posture.

### 2. Description of Related Art

It is well known that sitting for extended periods of time has negative effects on the body. Specifically, being in an improper position and having poor posture while sitting has many negative health effects, including but not limited to depression, stress, poor digestion, cardiovascular issues, back pain, abnormal spinal curve, sore or tense muscles, and headaches. Consequently, there is a need for an apparatus and system for improving sitting posture.

### BRIEF SUMMARY OF THE INVENTION

In one embodiment of the present invention an apparatus for improving sitting posture is provided, comprising a back support member having a top portion and a bottom portion; a first shoulder strap and a second shoulder strap attached to the top surface of the back support member; a first adjustable harness and a second adjustable harness positioned along the first and second shoulder straps respectively; and, a plurality of installation straps configured to secure the apparatus to a chair.

In one embodiment, the back support member is constructed from a foam cushion having a contoured shape including an upper portion and a lower portion, the lower portion providing lumbar support. In another embodiment, the foam cushion is covered with a fabric cover. In one embodiment, the first and second adjustable harness each includes an elastic section. In one embodiment, the plurality of installation straps comprise a first horizontal installation strap, a second horizontal installation strap, and a vertical installation strap, wherein the first and second installation straps are configured to be secured around a base section of a backrest of the chair, and the vertical installation strap is configured to go over the backrest from a top section and connect to the first and second horizontal installation straps for securement. In one embodiment, the bottom portion of the back support member abuts a seat of the chair. In another embodiment, a first quick release connector attached to the first adjustable harness and a second quick release connector attached to the second adjustable harness are provided.

In another aspect of the invention a system is provided, comprising a chair having a seat, a backrest, and a stem; an apparatus configured to improving sitting posture of a user sitting on the seat of the chair, the apparatus comprising a back support member having a top portion and a bottom portion; a first shoulder strap and a second shoulder strap attached to the top surface of the back support member; a first adjustable harness and a second adjustable harness positioned along the first and second shoulder straps respectively; and, a plurality of installation straps configured to secure the apparatus to the backrest of the chair, wherein a back of the user rests against the back support member and the first and second shoulder straps are configured to secure a torso of the user such that a neck of the user is prevented from leaning forward more than a predetermined distance.

In one embodiment, the back support member is constructed from a foam cushion having a contoured shape including an upper portion and a lower portion, the lower portion providing lumbar support to the back of the user. In another embodiment, the first and second adjustable harness each includes an elastic section such the predetermined distance is increased. In one embodiment, the plurality of installation straps comprise a first horizontal installation strap, a second horizontal installation strap, and a vertical installation strap, wherein the first and second installation straps are configured to be secured around a base section of the backrest of the chair, and the vertical installation strap is configured to go over the backrest from a top section and connect to the first and second horizontal installation straps for securement. In one embodiment, the bottom portion of the back support member abuts the seat of the chair. In another embodiment, the apparatus further comprises a removable strap configured to wrap around the stem of the chair such that the bottom portion of the back support member retains positioned abutting the seat of the chair. In yet another embodiment, the chair is an office chair. In one embodiment, the chair includes a pair of arm rests. In another embodiment, the apparatus further comprises a first quick release connector attached to the first adjustable harness and a second quick release connector attached to the second adjustable harness, the first and second quick release connectors enabling the user to be free of securement and exit the apparatus.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a front perspective view of an apparatus for improving sitting posture according to an embodiment of the present invention;

FIG. 2 is a side perspective view of an apparatus for improving sitting posture installed on an office chair according to an embodiment of the present invention;

FIG. 3A is a rear perspective view of FIG. 2;

FIG. 3B is a detailed view of detail 3B of FIG. 3A;

FIG. 4 is a front perspective view of an apparatus for improving sitting posture installed on an alternative office chair according to an embodiment of the present invention;

FIG. 5 is a rear perspective view of an apparatus for improving sitting posture installed on an alternative office chair in use according to an embodiment of the present invention;

FIG. 6 is a front perspective view of an apparatus for improving sitting posture installed on a vehicle seat according to an embodiment of the present invention;

FIG. 7 is a rear perspective view of an apparatus for improving sitting posture installed on the vehicle seat according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide an apparatus and system for improving sitting posture.

The object of the present invention is to provide a system enabling a user to adopt good sitting habits especially while sitting at a desk and working on a computer. For example, one instance of a poor sitting habit includes leaning forward with the neck extended, commonly referred to as a “hunched” posture. This position forces chest muscles to tighten, which can cause excessive curvature of the upper back, as well as other health concerns previously discussed. Thus, it is a particular advantage of the present invention to provide an apparatus and system preventing poor sitting habits. The details of the present invention will be described below.

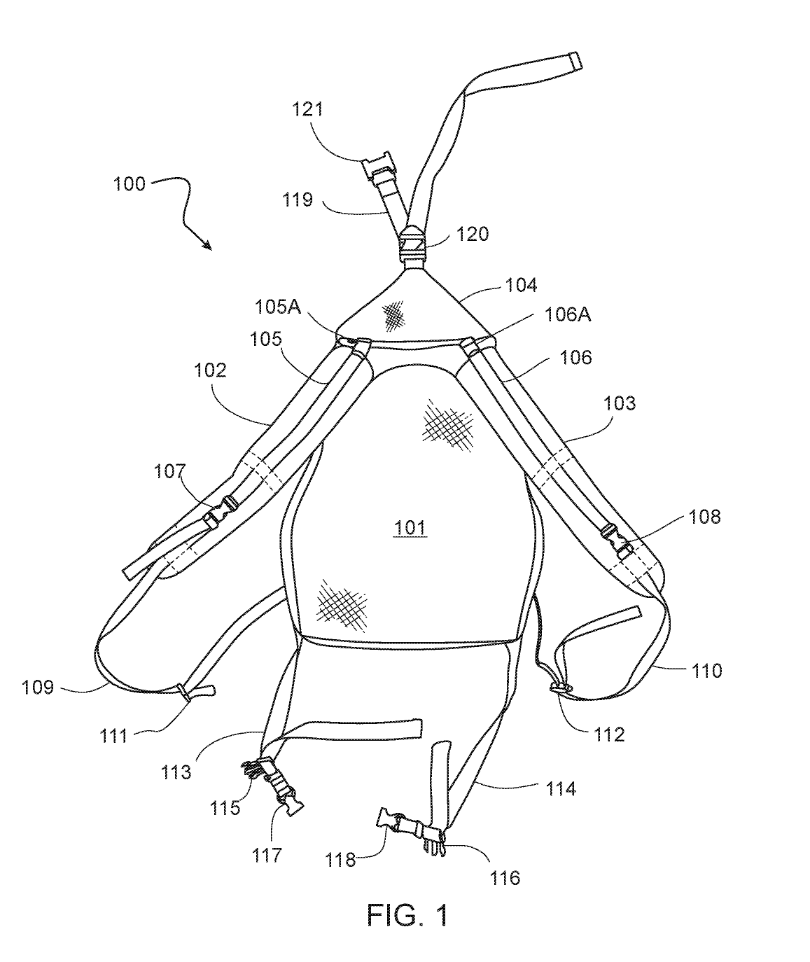

FIG. 1 is a front perspective view of an apparatus 100 for improving sitting posture according to an embodiment of the present invention. Referring now to FIG. 1, the apparatus is illustrated. The apparatus comprises back support member 101 having a first shoulder strap 102 and a second shoulder strap 103 attached thereto. In one embodiment, a positional securement member 104 is connected to the back support member at a top portion. The first and second shoulder strap includes a first and second adjustable harness 105 and 106 positioned along each shoulder strap respectively. In one embodiment, the first and second adjustable harness includes an adjustable section 109 and 110, each adjustable section including a buckle 111 and 112 configured to allow the adjustment of the first and second adjustable harness. Specifically, the harness length of each adjustable section may be adjusted depending on the size, height, and preferences of the intended user. In one embodiment, the first and second adjustable harness is connected to the first and second adjustable section via quick connection release members 107 and 108 respectively. The quick connection release members allow a user to exit the apparatus easily after the apparatus is installed to an office chair. This will be described in greater detail below.

Still referring to FIG. 1, the apparatus further comprises a pair of horizontal installation straps 113 and 114, and a vertical installation strap 119. These straps are provided to install the apparatus to an office chair, will be described in detail below.

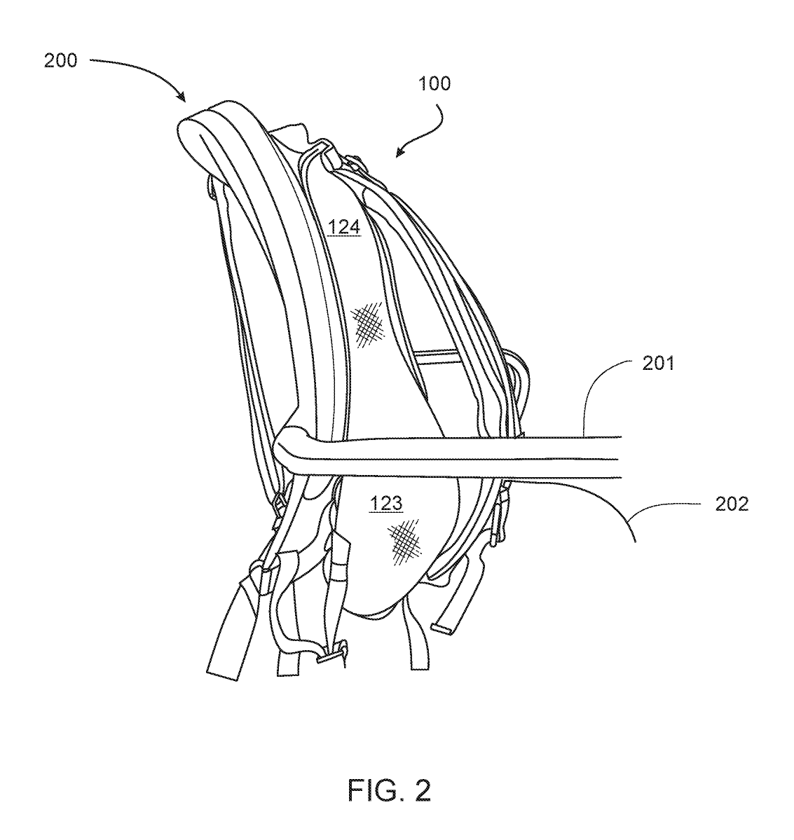

FIG. 2 is a side perspective view of an apparatus 100 for improving sitting posture installed on an office chair 200 according to an embodiment of the present invention. Referring now to FIG. 2, the office chair provided is an office chair that includes a pair of arms 201 and a seat 202 as well known in the art. It should be understood that any chair may be used, however as previously mentioned the purpose of the present invention is to improve the sitting posture of a user and often, poor sitting posture mostly occurs when a user is working at a desk or office like setting, sitting for hours at a time. Thus, the intended use for the apparatus is to be installed on an office chair.

Still referring to FIG. 2, the back support member has a contoured shape having an upper back portion 124 and a lower back portion 123. The shape of the lower back portion provides lumbar support. In one embodiment, the back support member is constructed from a foam cushion. In one embodiment, the foam cushion is covered with fabric (as illustrated) to protect the foam cushion and to keep the cushion sanitary during use. The size of the back support member may vary, depending on the size of the intended user. However, preferably the apparatus is configured to be able to be utilized by most users. Thus, preferably, the back support member is approximately 20 inches in height, 15 inches in width, having a length corresponding to the upper back portion and lower back portion of 2.5 inches and 3 inches respectively.

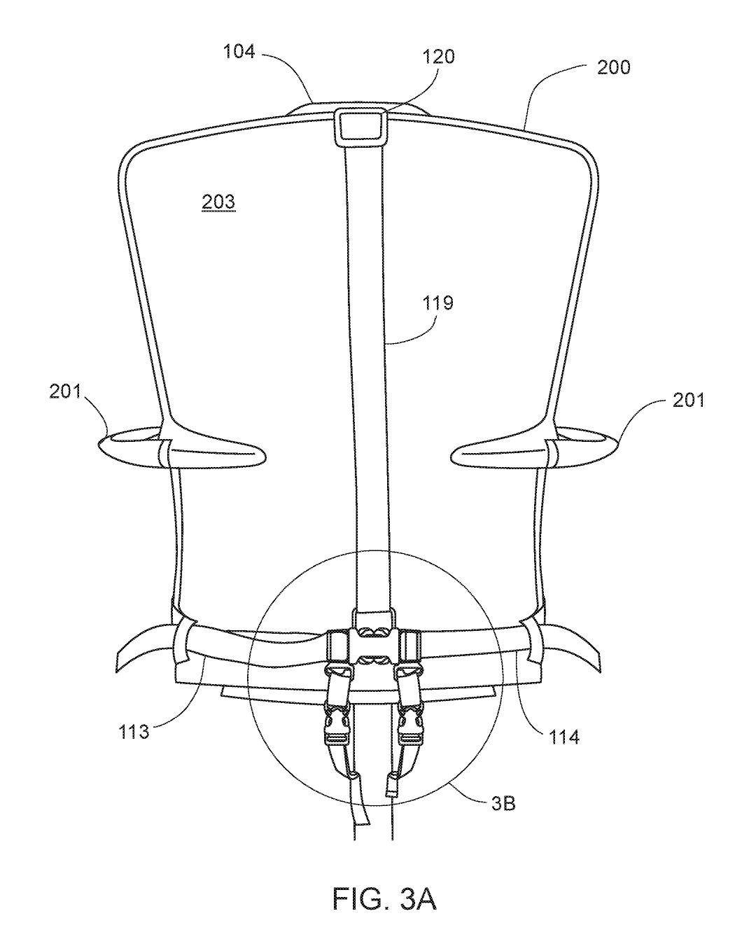

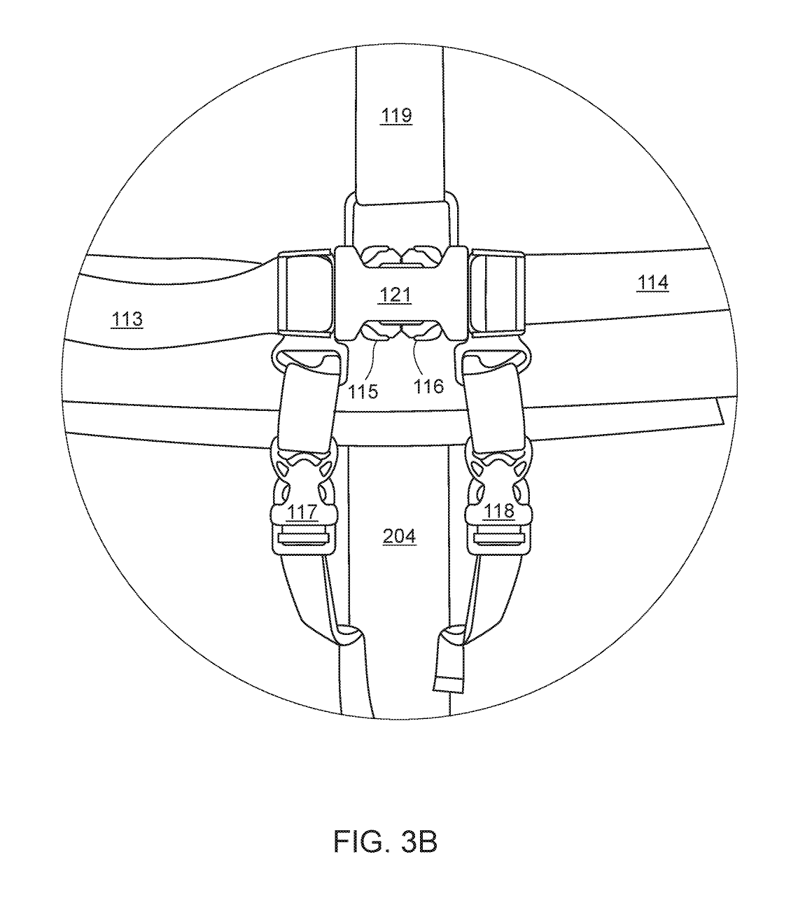

Referring now to FIGS. 3A-B, the details of installation of the apparatus to an office chair 200 will be described. Vertical installation strap 119 comprises a double connection component 121 at the distal end. The double connection component is configured to connect to a first and second side release buckle 115 and 116, wherein the first and second side release buckle is attached to first and second horizontal installation straps 113 and 114 respectively. In one embodiment, the vertical installation strap is adjustable in length via adjustment ring 120. As previously noted, the vertical installation strap is connected to positional securement member. The positional securement member is configured to be positioned along the top of the chair guiding the vertical installation strap into position along the center of the backrest 203 of the chair. The positional securement member also helps prevent indentation from the vertical installation strap on the top of the chair via the vertical installation strap's pressure when tightened and secured. In one embodiment, the positional securement member is constructed from a triangular shape extending from each side of the back support member. In one embodiment, the vertical installation member is connected to the positional securement member such that it is positioned in the center of the back support member providing optimal balance and support.

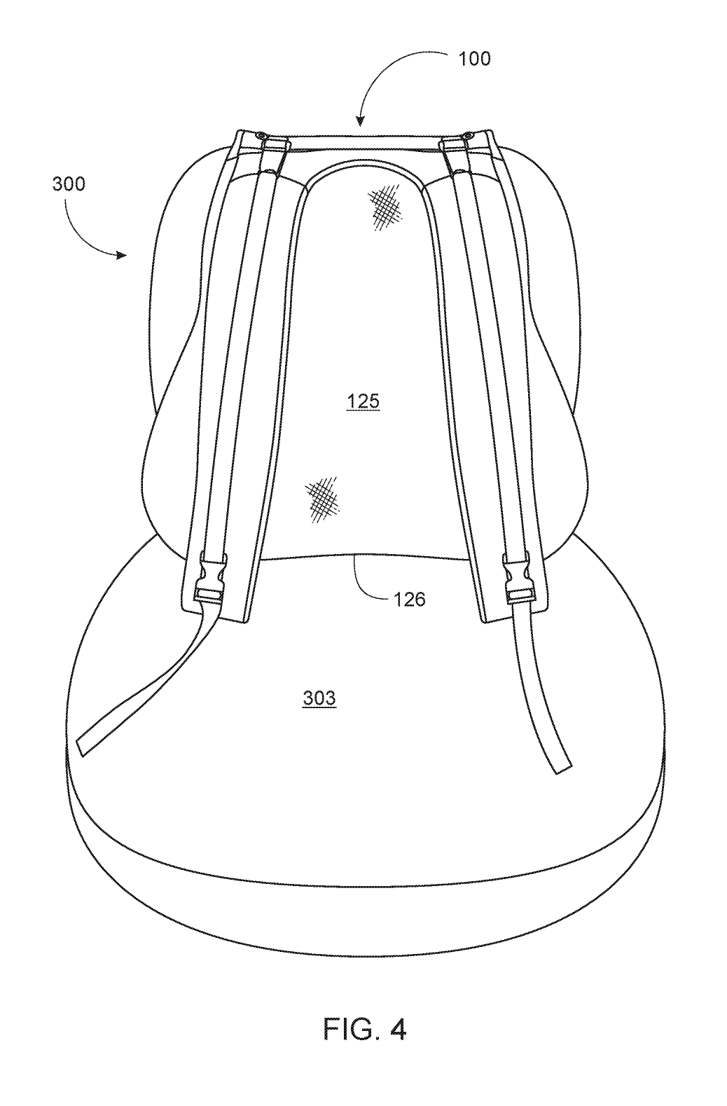

During installation, the first and second horizontal installation straps are wrapped around the office chair towards the base of the office chair as illustrated in FIG. 3A. Next, first and second side release buckles 115 and 116 are engaged with the double connection component 121 from the vertical installation strap that is configured to go around the chair backrest and connect to the first and second horizontal installation straps around the base of the chair backrest. These three installation straps are necessary to secure the apparatus to the chair during use. Each strap of the three installation straps are adjustable allowing the user to tighten each strap until the apparatus if firmly secured on the chair back, ideally with the bottom potion 126 (FIG. 4) of the back support member touching or abutting the chair seat.

During use, a user sits on the chair and places their arms through the first and second shoulder straps, then tightens the first and second adjustable harnesses until secure. It is a particular advantage of the present invention, that once the user is secure in the apparatus, the user is limited in movement, which helps the user to sit properly on the chair, specifically with the back of the user against the back support member, without allowing the user from leaning forward and extending their neck forward, or moving to the edge of the chair. Utilizing the first or second quick connection release member, the user is enabled to easily be free of securement and exit the apparatus, without removing or loosening the installation straps. Likewise, the user can use the connection release members to resecure themselves to the apparatus without requiring the apparatus to be reinstalled. That is, the apparatus can be conveniently left installed on the chair.

The installation straps may loosen over time. If loosened, the straps may be retightened to reestablish a firm securement. Alternatively, an optional removable strap 112 may be used to add an additional means to secure the apparatus, and specifically the back support member position during use. The optional removable strap helps prevent the back support member from rising off the chair seat or rising up the seat back during use, if the installation straps loosen. In one embodiment, the optional removable strap connects to buckles 117 and 118, connected to the first and second horizontal installation straps respectively. The optional removable strap is configured to wrap around a stem 204 of the office chair.

FIG. 4 is a front perspective view of an apparatus 100 for improving sitting posture installed on an alternative office chair 300 according to an embodiment of the present invention. Referring now to FIG. 4, the apparatus may be installed on alternative office chairs having no arms as illustrated. Also in the view, front portion 125 of the back support member is shown and it can be seen that bottom portion 126 of the back support member abuts seat 303 during use.

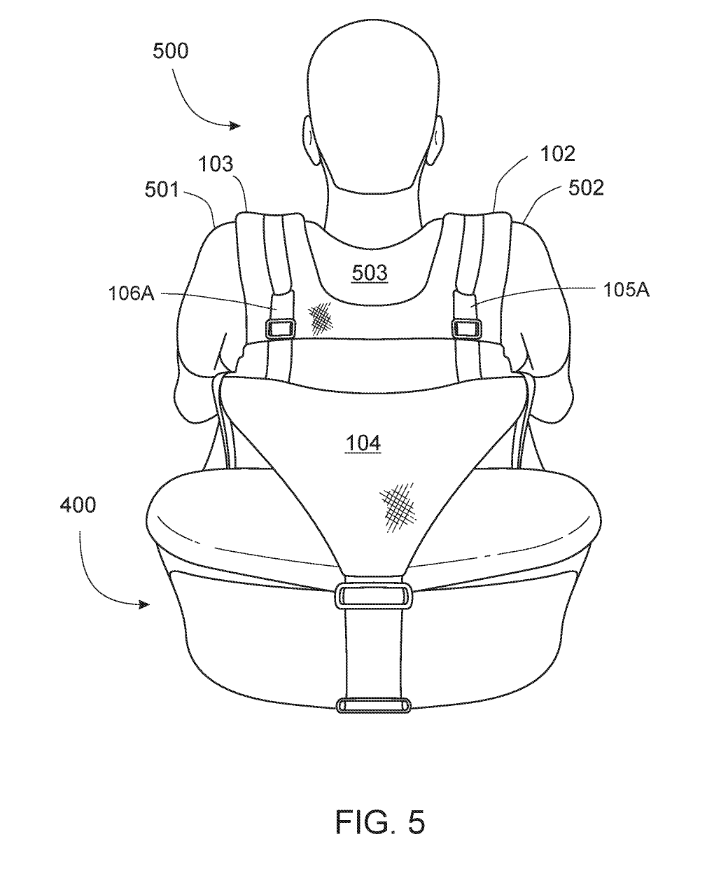

FIG. 5 is a rear perspective view of an apparatus 100 and system for improving sitting posture installed on an alternative office chair 400 in use according to an embodiment of the present invention. Referring now to FIG. 5, the apparatus in use is illustrated. As previously mentioned, the apparatus comprises a first and second shoulder strap 102 and 103, each shoulder strap having an adjustable harness 105 and 106. In one embodiment, each shoulder strap comprises an elastic section 105A and 106A configured to allow the user extra mobility when needed. During use, a user 500 after installing the apparatus for use on office chair 400, positions the first and second shoulder strap over their right and left shoulders 502 and 501 respectively. The back of the user 503 is positioned against the back support member 503. It is a particular advantage of the present invention prevents the neck 504 of the user from leaning forward too much, such that neck pain and issues may arise. Once secured, the amount of mobility is predetermined depending on how tight the adjustment harnesses are during securement. Preferably, the user has no mobility from their torso preventing the user from leaning forward too much or at an extreme distance. The elastic straps allow for the user to exceed the predetermined mobility. However, the tension in the elastic straps prevents the user from exceeding the predetermined mobility for extending periods. The elastic straps are useful when the user needs to reach for an item, such as a pen, that is outside the standard (tension free) mobility during use.

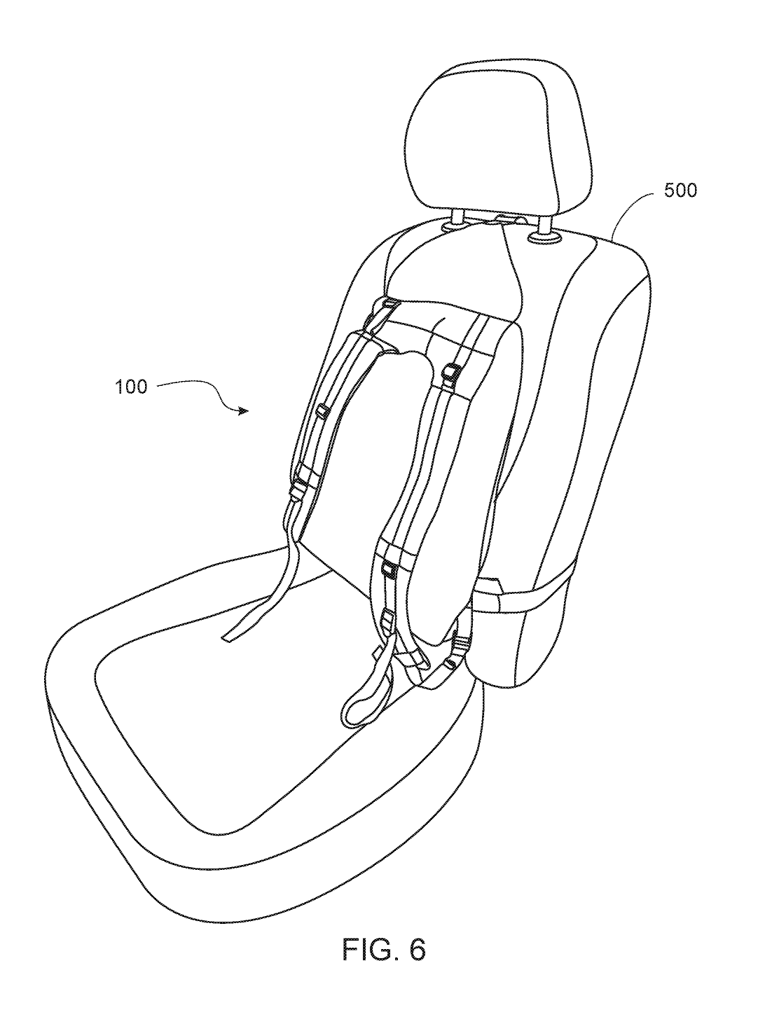

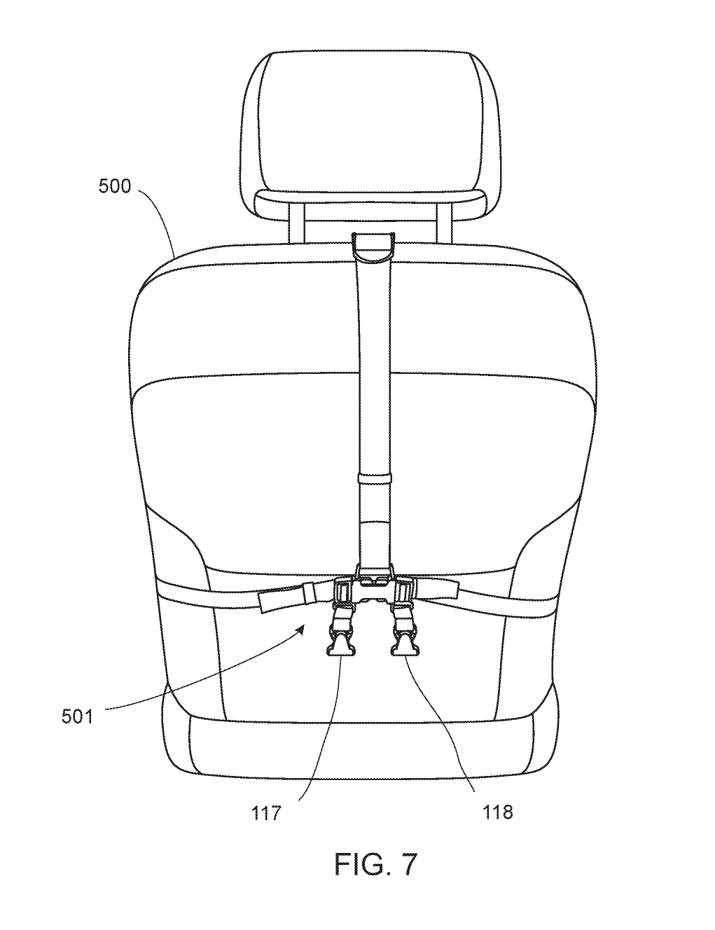

Referring now to FIGS. 6 and 7, apparatus 100 for improving sitting posture installed on vehicle seat 500 according to an embodiment of the present invention. It can be appreciated that the following example illustrates the use of the apparatus in various environments. In this embodiment, the attachment is similar as previously described however buckles 117 and 118 and the optional removable strap is not used. Thus, in this embodiment, the apparatus improves the sitting posture for a user that is driving a vehicle. The apparatus does not affect the use of the existing seatbelt or driving ability.

Although the invention has been described in considerable detail in language specific to structural features and or system acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. An apparatus for improving sitting posture comprising:
a back support member having a top portion and a bottom portion;
a first shoulder strap and a second shoulder strap attached to the top surface of the back support member;
a first adjustable harness and a second adjustable harness positioned along the first and second shoulder straps respectively; and,
a plurality of installation straps configured to secure the apparatus to a vehicle seat.

2. The apparatus for improving sitting posture of claim 1, wherein the back support member is constructed from a foam cushion having a contoured shape including an upper portion and a lower portion, the lower portion providing lumbar support.

3. The apparatus for improving sitting posture of claim 2, wherein the foam cushion is covered with a fabric cover.

4. The apparatus for improving sitting posture of claim 1, wherein the first and second adjustable harness each includes an elastic section.

5. The apparatus for improving sitting posture of claim 1, wherein the plurality of installation straps comprise a first horizontal installation strap, a second horizontal installation strap, and a vertical installation strap, wherein the first and second installation straps are configured to be secured around a base section of a backrest of the vehicle seat, and the vertical installation strap is configured to go over the backrest from a top section and connect to the first and second horizontal installation straps for securement.

6. The apparatus for improving sitting posture of claim 1, wherein the bottom portion of the back support member abuts a seat of the vehicle seat.

7. The apparatus for improving sitting posture of claim 1, further comprising a first quick release connector attached to the first adjustable harness and a second quick release connector attached to the second adjustable harness.

8. A system comprising:
a vehicle seat having a seat and a backrest;
an apparatus configured to improving sitting posture of a user sitting on the seat, the apparatus comprising:
a back support member having a top portion and a bottom portion;
a first shoulder strap and a second shoulder strap attached to the top surface of the back support member;
a first adjustable harness and a second adjustable harness positioned along the first and second shoulder straps respectively; and,
a plurality of installation straps configured to secure the apparatus to the backrest of the chair, wherein a back of the user rests against the back support member and the first and second shoulder straps are configured to secure a torso of the user such that a neck of the user is prevented from leaning forward more than a predetermined distance.

9. The system of claim 8, wherein the back support member is constructed from a foam cushion having a contoured shape including an upper portion and a lower portion, the lower portion providing lumbar support to the back of the user.

10. The system of claim 8, wherein the first and second adjustable harness each includes an elastic section such the predetermined distance is increased.

11. The system of claim 8, wherein the plurality of installation straps comprise a first horizontal installation strap, a second horizontal installation strap, and a vertical installation strap, wherein the first and second installation straps are configured to be secured around a base section of the backrest, and the vertical installation strap is configured to go over the backrest from a top section and connect to the first and second horizontal installation straps for securement.

12. The system of claim 8, wherein the bottom portion of the back support member abuts the seat.

13. The system of claim 8, wherein the apparatus further comprises a first quick release connector attached to the first adjustable harness and a second quick release connector attached to the second adjustable harness, the first and second quick release connectors enabling the user to be free of securement and exit the apparatus.
